(19) United States
(12) Patent Application Publication
(10) Pub. No.: US 2015/0120479 A1
(43) Pub. Date: Apr. 30, 2015

(54) CATALOG DRIVEN ORDER MANAGEMENT FOR RULE DEFINITION

(71) Applicant: International Business Machines Corporation, Armonk, NY (US)

(72) Inventors: Alphonse J. Bastien, Markham (CA); Vincent K. Choi, North York (CA); Jason De Vellis, Toronto (CA); Izabella Gabowicz, Etobicoke (CA)

(73) Assignee: International Business Machines Corporation, Armonk, NY (US)

(21) Appl. No.: 14/064,309

(22) Filed: Oct. 28, 2013

(51) Int. Cl. G06Q 30/06

(52) U.S. Cl. CPC G06Q 30/0603
USPC 705/26.1

(57) ABSTRACT

A product template is created from attributes of an offer for a product by defining a template conditional behavior as a function of a set of selectable data values of the attributes. The product template is translated into a first export that has a first syntax that is executable by a rule engine of a first of a set of business support, operations support and/or operating systems to generate a first rule that is representative of the conditional behavior for the first product and executable by the first system. The product template is also translated into another export that has a second syntax that is different from the first syntax and is executable by a rule engine of a second of systems to generate a second rule that is representative of the conditional behavior for the product and is executable by the second system.

### FIELD OF THE INVENTION

The present invention relates to automated and programmable mechanisms that use a central repository to store and manage data consumed by multiple business systems.

### BACKGROUND

Catalog-driven order management refers to automated, programmable computing device structures that use a central repository, sometimes referred to as a “product catalog,” to store and manage data consumed by multiple, different business systems. Business systems include systems for quote, capture, fulfillment or billing functions within a business environment. Catalog-driven order management enables data to be managed in a central reference point for enterprises that use multiple legacy systems for their operations or business support processes, which do not have the same way of representing product data. Catalog order management may store data definitions in a product catalog that are used to decompose a product into constituent parts. For example, a five megabyte (5 MB) high-speed data product may be broken down to constituent components in the catalog that include a 5 MB service, an email service, a firewall service, and a specific type of modem.

### BRIEF SUMMARY

In one aspect of the present invention, a method for maintaining dynamic product behavior data via a product catalog includes a processor creating a first product template from attributes of an offer for the first product by defining a template conditional behavior as a function of a set of selectable data values of the attributes. The processor translates the first product template into different product template exports that each have different, executable syntaxes. Thus, the processor translates the first product template into a first product template export that has a first syntax that is executable by a rule engine of a first of a set of business support, operations support and/or operating systems to generate a first rule that is representative of the conditional behavior for the first product and executable by the first system. The processor further translates the first product template into another first product template export that has a second syntax that is different from the first syntax and is executable by a rule engine of a second of the business support, operations support and/or operating systems to generate a second rule that is representative of the conditional behavior for the first product and is executable by the second system.

In another aspect, a system has a processor, computer readable memory and a computer-readable storage medium with program instructions, wherein the processor, when executing the stored program instructions, creates a first product template from attributes of an offer for the first product by defining a template conditional behavior as a function of a set of selectable data values of the attributes. The processor thereby translates the first product template into different product template exports that each have different, executable syntaxes. Thus, the processor translates the first product template into a first product template export that has a first syntax that is executable by a rule engine of a first of a set of business support, operations support and/or operating systems to generate a first rule that is representative of the conditional behavior for the first product and executable by the first system. The processor further translates the first product template into another first product template export that has a second syntax that is different from the first syntax and is executable by a rule engine of a second of the business support, operations support and/or operating systems to generate a second rule that is representative of the conditional behavior for the first product and is executable by the second system.

In another aspect, a computer program product for maintaining dynamic product behavior data via a product catalog has a computer-readable storage medium with computer readable program code embodied therewith. The computer readable program code includes instructions that, when executed by a processor, cause the processor to create a first product template from attributes of an offer for the first product by defining a template conditional behavior as a function of a set of selectable data values of the attributes. The processor thereby translates the first product template into different product template exports that each have different, executable syntaxes. Thus, the processor translates the first product template into a first product template export that has a first syntax that is executable by a rule engine of a first of a set of business support, operations support and/or operating systems to generate a first rule that is representative of the conditional behavior for the first product and executable by the first system. The processor further translates the first product template into another first product template export that has a second syntax that is different from the first syntax and is executable by a rule engine of a second of the business support, operations support and/or operating systems to generate a second rule that is representative of the conditional behavior for the first product and is executable by the second system.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of aspect according to the present invention for defining template behavioral properties for use with similar products.

FIG. 2 is a flow chart illustration of aspect according to the present invention for using defined template behavioral properties with similar products.

FIG. 3 provides a graphic illustration of an implementation of an aspect of the present invention.

FIG. 4 is a block diagram illustration of a computer system implementation of an aspect of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes transitory, propagation or carrier wave signals or subject matter and includes an electronic, magnetic, optical or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that does not propagate but can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic or optical forms or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions, which execute on the computer or other programmable apparatus, provide processes for implementing the functions/acts specified in the flowchart and/or block diagram block or blocks.

Behavior rules are dynamic product data that governs how products should behave, such as how a product should be priced, when it can be made available to customers, etc. Behavior rules are typically entered and maintained directly within each of different, individual consuming operational support systems (OSS), business support systems (BSS) or operating systems (OS) within an enterprise that share product data, sometimes via use of a common product catalog.

Data de-synchronization may occur across the different consuming systems if product behavior rules are implemented inconsistently through different, disparate processes in the individual systems. Because each of the systems may have their own unique syntax and structure, each system must typically define rules differently to utilize them. Writing rules in a specific syntax is non-trivial and usually requires specific technical skills to learn the syntax used by a given rules engine, and making sure the right variables are selected, etc. Rules engines within the different consuming systems may also use different specialized user interfaces (UI's) to help users with writing rules correctly in a way that their respective engines understand. Moving the data entry of the different behavior rules from different respective rules engines to a centralized catalog may inhibit the ability to use special UI's.

Aspects of catalog-driven order management according to the present invention store and manage product behavioral properties that govern how products should behave in a centralized product catalog by using a template methodology described below. Aspects extract the essence of product behaviors into a set of business-relevant properties defined within product templates that are settable and updatable within the centralized repository, and which are subsequent exported in a variety of different system syntaxes and formats to individual business system consumers for use with their different respective rules engines in generating behavior rules for the template behavior properties. Entry and update of dynamic behavioral data need occur only once and directly in the repository, wherein the data inputs and updates may be efficiently propagated to the individual consuming OSS/BSS systems through different exports in appropriate syntax executable at run-time by each of the systems. This template approach reduces exposures to data de-synchronization by centralizing behaviors that drive how a product should be priced, or when it can be made available to customers, or who is eligible for the product, etc., within one common repository. This also enables streamlining of maintenance of the different versions of behavior rules propagated by each of the consuming systems, by achieving said maintenance through revisions and inputs to settable, business-recognizable properties in one, consuming-system-independent format.

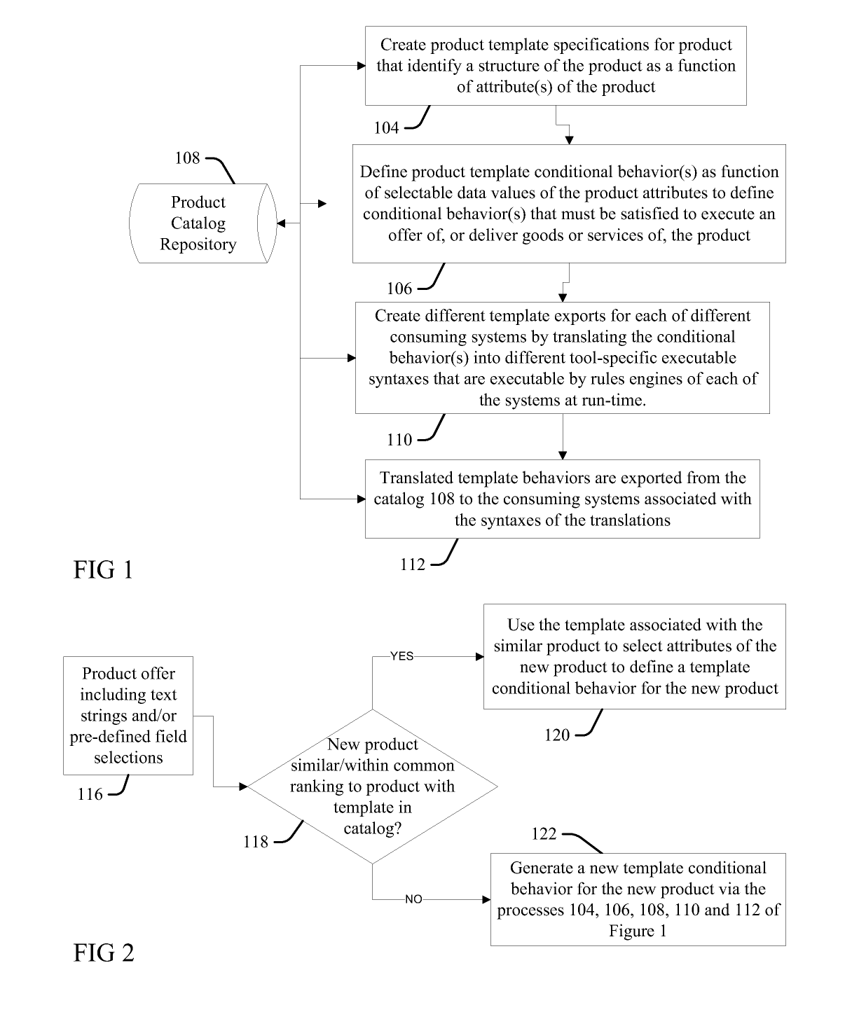

FIG. 1 illustrates an aspect of the present invention for maintaining dynamic product behavior data via a product catalog in a catalog-driven order management environment. At 104 the processor creates a product template that includes one or more (a set or plurality of) specifications for a (first) product that each identifies a structure of the product as a function of one or more of the attributes of the product that are captured from an offer input. At 106 the processor defines dynamic product data, namely a set or plurality of conditional behavior properties for the product template as selectable data values that are each associated with captured product attributes of the set of specifications and define one or more conditional behaviors associated with the product that must be met to execute the offer or otherwise deliver the goods or services (hereinafter sometimes “product template properties” or “conditional behavior properties”). The conditional behaviors are not defined as executable rules, but define non-static, behavior-driving data that are usable (when exported into an appropriate syntax) at run-time by individual consuming systems to realize dynamically different behavior based on different specific scenarios or combinations of selectable data values with the captured specification attributes that must be met or satisfied in order to present the offer or deliver the goods or services defined by the offer. For example, the presentment of an offer for a given product to a given consumer (such as a specific speed of internet service) may be dependent upon recognizing that consumer has purchased, subscribed to, or ordered another specified product, or on qualities of the customer (service location, customer type, segment), etc.).

The product template created at 104 and 106 is saved and maintained in a single product catalog repository 108 (hereinafter sometimes “catalog” or “product catalog” or “repository”) that is in communication via network or other interface structures with each of a plurality of different consuming systems, for example business support systems, operations support systems or operating systems (not shown in this view) that each use different data and rule syntaxes.

At 110 the processor creates different product template exports for different ones of the consuming systems in communication with the repository by translating the product template conditional behavior properties (and any associated offer attribute specifications as needed) into their respective different tool-specific syntaxes that are executable by rules engines of each of the systems at run-time. The product template exports are also stored in the catalog 108. At 112 the translated product template behavioral properties are exported from the catalog 108 to the consuming systems associated with the syntaxes of the translations, for use with their respective rule engines. More particularly, a first one of the systems has a rules engine that uses a tool-specific syntax that is different from the syntax used by rules engine of another of the systems, and the export at 112 includes exports of the appropriate syntax to each of these rules engines, thereby enabling each of said different systems to generate a behavior rule consistently throughout the systems, albeit in each of the different respective syntaxes of their own rule engines. Thus, behavioral properties may be set by a user once in the product catalog, and then disseminated to the various consuming systems in a format that is understandable to each of the different consuming systems at 112.

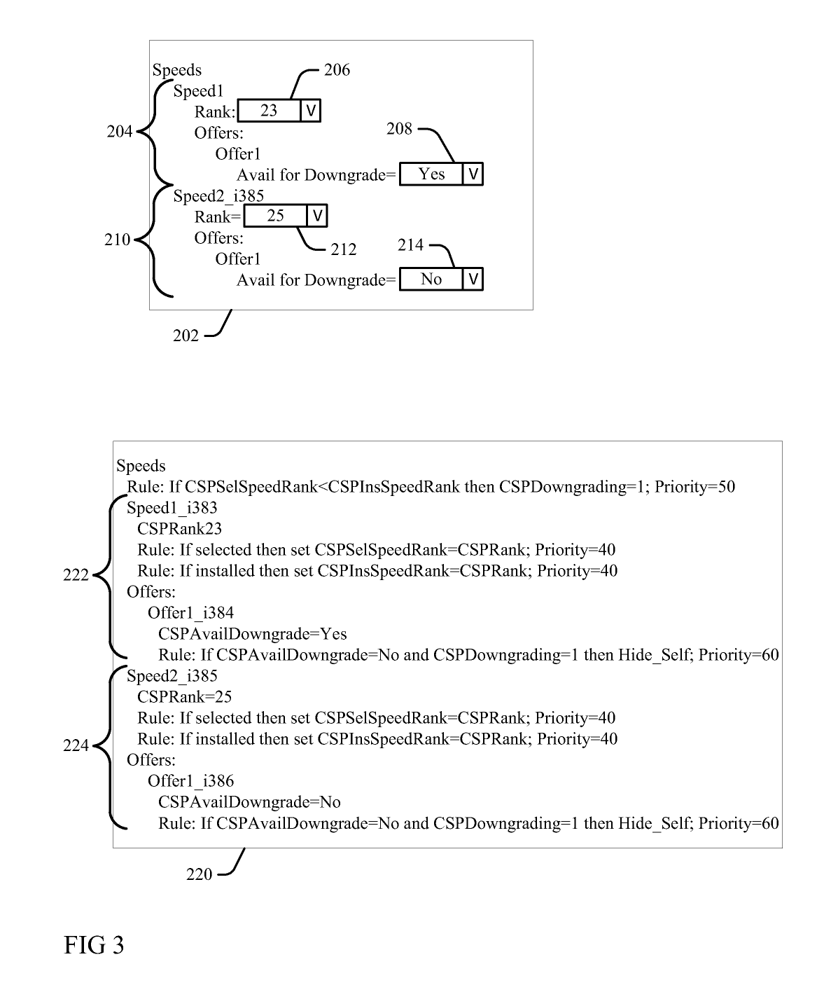

FIG. 2 illustrates another aspect of the present invention. A product or offer is input at 116, for example by a user via a graphical user interface (GUI) or other input mechanism, that includes text string descriptions or selections of pre-defined choices of attributes that include descriptions of goods or services, parties offering the goods or services and/or a conditional behavior required for delivery or execution of the goods or services associated with the product. The input at 116 is subsequent to definition of a product template stored in the central catalog 108 (as discussed above with respect to FIG. 1). At 118 the process determine whether the new product is similar to or belongs to a common product grouping or category with a product for which an existing template has been defined and stored in the catalog 108. For example, does the new product behave along similar dimensions (similarly) to, an existing product or offer associated with a template already defined and stored in the catalog 108. Examples of criteria for determining whether products belong to a common product grouping or category include determining whether they have a common relative ranking of respective values of a common specification field, or whether they have respective values of a common specification field that each meet a threshold value, and still other appropriate criteria will be apparent to one skilled in the art.

If determined at 118 that the new product is similar to a product associated with an existing template, then at 120 the existing template of the similar product is applied to the new product, by selecting attributes of the new product for use in defining behavioral properties (for example, which ones need to be collected from users via GUI interfaces, etc.), and to define selectable values of the selected attributes to define conditional behavior properties for the new product. And then the template would be used to select attributes of the new product and define for the new product as a set of selectable data values that are associated with the selected attributes of the new product. Thus, the conditional behavior that must be satisfied to execute an offer of, or deliver goods or services of, the new product, is defined by the selectable values. For example, if an existing template is defined for an internet service provider data product having a given speed, and if the new product is similar (a data product from the same provider but having a different speed), then the salient attributes of the new product are applicable to and populated into the existing product template to create an eligibility behavior condition for the new product. The conditional behavior may be a determination as to whether a user qualified for an upgrade based on dates of prior service acquisition, current speed and rates paid for that speed, etc., as a function of the different speed of the second product.

If however it is determined at 118 that the new product is not similar or within the same category, etc., as any other product associated with a template stored in the catalog, then at 122 another template is generated for the new product by repeating the processes at 104, et seq., of FIG. 1.

FIG. 3 illustrates an example of an implementation of an aspect of the present invention. A graphical user interface window 202 provides an interface for receiving offer input data (at 116 of FIG. 2) with regard to different levels of internet services. “Speed 1” is a first product offer 204 of a level of speed of internet services that is entered by a user and assigned a rank of 23 through a pull-down box field 206, and marked as eligible for presenting in a downgrade offer via selection of the downgrade field box 208. A second product “Speed 2” 210 is similar to the first product 204 but has a different level of speed of internet service that is either manually assigned a relative rank of 25 through an associated pull-down box field 212 and marked as ineligible for presenting in a downgrade offer via selection of the associated downgrade field box 214, or wherein some or all of the product data is automatically created by cloning (at 120) from specification templates generated for the first product that include the rank and downgrade eligibility fields. Thus, aspects may create selectable data values for the fields 212 and/or 214 at 106 for new products (such as “Speed 2” 210), or adapt product template specifications previously defined at 104 to support behavior definitions reflected by 212 and/or 214.

Window 220 illustrates a set of rules 222 generated by a rules engine of a consuming system as a function of one or conditional behavior properties generated for the first Speed 1 product 204 as a function of the rank 206 and downgrade 208 specification. In some aspects the rule set 222 is created manually by a technical user; and in others automatically by a rules engine in a business support, operations support or operating system in communication with the catalog 108 as a function of the specification exports created at 110 and the tool-specific syntaxes translated at 112 from the product template generated at 104 and 106 from the Speed 1 product 204 data 206 and 208 and translated at 112 into appropriate system syntax and exported at 114. The rule set 222 template defines behaviors, properties and rules for subsequent similar or commonly categorized products, such as Speed 2 product 210.

In response to determining at 118 that the two products 204 and 210 are similar, the rule set 222 serves as a template for the Speed 2 product 210 during its addition to the catalog 108 at 120. Thus, the template defined for the first product 204 is populated with the values of the second product 210 (at 120), and a second rule set 224 is generated by a rules engine of a consuming system as a function of one or conditional behavior properties generated for the second Speed 1 product 210 as a function of the data specification values 212 and 214 of the second Speed 2 product 210. In this fashion the rules for behavior defined for the first product 204 are automatically applied to the second product 210, but the outcomes of the applied rules vary due the different data specification values 212 and 214 (for example, the first product 204 may be presented with downgrade offers, but the other product 210 may not).

In some aspects an “Extract, Transform and Load (ETL) injection process uses product definition data of an the existing product template to generate a template for a new, similar product, wherein property values of the new product from a product definition system or process are applied in a rules definition system or process. Aspects also write system rules at 120 in proper syntax for each networked system based on user inputs provided to the template, generating future system rules when new products and attribute values are entered subsequently.

The template is reused each time similar or commonly categorized new product inputs are received, and populated with the attributes values of the new product, service etc. The behaviors defined by the template do not change with each reuse; however the outcomes, the different conditions and actions that may happen via application of the rules generated at run-time in each rule engine may differ based on the user input variables. For example, different options and behaviors may flow out of a value of a binary variable that indicates whether the new product is down gradable or non-down gradable.

If the new product is determined to be similar at 118, the consuming business support systems, operations support systems or operating systems also receive the product information from the catalog 108, along with the template properties that the new, similar product should be emulating, plus the product-specific values of the behavioral properties that are applicable for reuse of that template for the new product. The systems may then use all this template data to execute dynamic product behavior, for example during application of different quote, order capture, fulfillment or billing systems, without requiring a user to enter or update any of the product rules in these systems. This results in reduced time-to-market and reduced costs for new product/offer introductions.

By structuring product template properties as selectable data values that are associated with product specifications, rather than creating rules that are specific to rule engine syntaxes, aspects of the present invention provide one single tool that provides a complete view of how the product or offer behaves in specific scenarios through a variety of different systems and rule engine implementations spanning disparate rule syntaxes. Data entry only performed once with respect to a new product or offer results in product data being transformed multiple times (including into different system syntaxes), at least once for each system integrated via a central catalog repository 108 that needs to execute rules to enforce desired behaviors.

Maintaining templates for rules behavior in the product catalog enables users to enter behavioral and product data once in a centralized location without necessitating additional rules entry into the individual consuming systems. Maintenance costs are reduced as a result, and a single view of related product data for an enterprise may be provided that mitigates the risk of de-synchronized product behavior in constituent subscribing systems (for example, quote, order capture, fulfillment and billing systems).

Translation logic leverages defined templates for new, similar products to specify how each property value should be transformed into a given syntax that is expected or required by each of the system rules engines. Thus, minimal testing is required for similar products or offers that share in common a template once the template behavior translation logic is tested, allowing rules to be subsequently abstracted at the individual system level or domain into different, business-specific properties.

Storing and managing data consumed by multiple business systems (for example, for quote, capture, fulfillment or billing functions) within the central repository 108 enables data to be managed in a central reference point for enterprises where multiple legacy systems exist that do not use the same way of representing product data. The know-how for decomposing and transforming product data from one system's representation to another's system representation is stored and managed in the catalog/repository 108 and pushed to the individual consuming systems.

Product management costs are decreased by managing the static and dynamic product data required by all the different business support, operating support and operating systems in the catalog, and by exporting the managed data in different respective formats required by the systems, in one aspect as updates are only performed once in the centralized location. For example, in response to entering an update of the definition or possible values of a variable behavior field in the product offer attributes, some aspects automatically update the existing templates stored in the repository by repeating the processes of FIG. 1 for each template.

By managing relationships between products in the centralized catalog (for example, storing that product A is a bundle of component products X, Y and Z), different order management systems can apply generic logic to decompose the products into their components, saving on maintenance costs and time when product relationships change. Further, by managing behaviors or rules for transforming product data between legacy order capture, fulfillment or billing systems in the catalog, enterprises can retain their legacy system investments.

In the prior art the rules governing quoting, order capture, fulfillment and billing and other product behavior are maintained directly in the different business support, operations support or operating systems. Migrating individual system rules into the catalog would centralize them, but because each system has its own unique syntax and structure this would not reduce duplicated rule management efforts because some of the systems define rules differently. This would also prohibit users from using specialized user interfaces (UI's) to facilitate rule management. Prior art approaches, wherein the rules are maintained in multiple systems, also create risks of exposure to data de-synchronization across the systems that arise if the product rules are implemented inconsistently through their disparate processes.

By using a template for rules behavior that is maintained in the central product catalog/repository, aspects of the present invention enable users to enter behavioral product data once in a centralized location without necessitating additional rules entry in the individual consuming systems. As a result, maintenance costs are reduced, there can be a single view of order-to-cash related product data for the enterprise, and the risk of de-synchronized product behavior in quote, order capture, fulfillment and billing systems is mitigated.

The centralized product catalog becomes a source of truth for product data because it is the point of entry for all static and dynamic (i.e. behavioral) data. Users of the catalog are presented with a unified view of the product data and may trust that all the consuming, operational systems reflect the same static and dynamic data.

Project-based cost savings for the operational systems responsible for quoting, order capture, fulfillment and billing are also realized. To perform these tasks each of the systems generally requires its own rules engine to execute the rules constraining product behavior. A typical implementation of a configuration rules engine may involve hundreds of products, and thousands of rules and of possible combinations of the above. Traditionally, each product or offer would be modeled individually, resulting in a high number of rules. This translates to not only high development and maintenance costs, but also high testing costs in conventional systems, and further a high number of rules that require a correspondingly high number of test cases to validate the correctness of the product modeling and rules definition.

Aspects group products to be modeled into categories of products that have similar behavior, and based on these similarities to a single set of template product properties for each category of product may be defined. Each category of product can support a pre-defined set of applicable behavioral properties defined in the product template, wherein product rules for that category or template are written by the individual system rule engines such that they look at the values of these properties in determining how or if to run a product rule. Thus, instead of modeling and exhaustively testing large volumes of products, aspects of the present invention model and test only the (usually) much smaller number of product templates, because the behaviors represented by the generated rules are themselves generic. The template properties are abstractions of minor behavioral differences between similar products, and the use of a template-based approach to modeling reduces the cost of implementation and testing of large numbers of products, as well as reduces ongoing testing costs, relative to conventional approaches. Time to market of new product introductions to an existing template may be significantly reduced because rule definitions are not input in different formats across multiple systems. Furthermore, aspects centralize the setting of these template property values in the centralized product catalog 108, which may be accomplished by user without specialized skills in any of the different, individual business support, operating support and operating systems or their respective syntaxes.

In some aspects of the present invention a product definition system operated by the processor is used by business users to create new products based on existing templates, wherein specifications are selected or created to identify the product's structure and behavior-impacting properties associated with the structure. A rule definition system function enables rule editors (also sometimes referred to as “modelers”) to create product template properties at 106 that define behavior-impacting product properties for export to individual system rule engines from the product definition system, wherein rules created in response by the rule engines operate in compliance with the behaviors defined by the exported template properties.

Other examples of application of the aspects of the present invention as responsive to offer inputs of pricing stock keeping unit (SKU) specifications exported, wherein a product definition system used by a rule system looks up price values for the product to define a specification or property for export. A telephone package product input may include a number of phone services, wherein a product definition system defines a behavior property that specifies how many services each package includes, for use by system rule engines to define rules to use the property for the number of products, which may include setting a price for that number to zero. A television offer may specify the classification or the exact product identifier that should be discounted if present on a customer's account, so that rules are defined by using a property to determine for which product the price should be adjusted, if any. An internet offer may only be available to customers who are upgrading their services, wherein rules are defined by using a property to identify if availability of the offer should be restricted to this upgrading condition.

In some aspects products are categorized in a hierarchy in the central catalog 108, and the location of a product within the hierarchy determines which template is selected for application to the product. For example, if the products are proximate enough to each other within the hierarchy (within a threshold distance value), they are considered common products to trigger a use of the first product template to generate templates for the new product. However, it will be understood that similarity between two products is not generally bounded by their relative hierarchical placement. For example, two products may be considered similar even if they are organized far apart in a hierarchy if they have the same fixed specifications and the same variances in how they can behave (i.e., they would be bounded by the same type of rules). Moreover, while an appropriate template may be selected the based on hierarchy location, this does not preclude selection based on how those products are represented in the real world, which may enable a determination of similarity even if they are organized into a hierarchy differently.

The templates are used identify the collection of properties that must be set to effect differentiated product behavior (i.e., non-static data) in consuming systems at run-time (e.g., quoter, product configurator, order management system, biller or other system). Product attributes, template specifications or template properties may also be used to select matching, pre-defined rule patterns or workflows. Product input attributes, as well as template specifications and properties may be described directly in business terms, for example “need product X to qualify,” or “available only when upgrading service.”

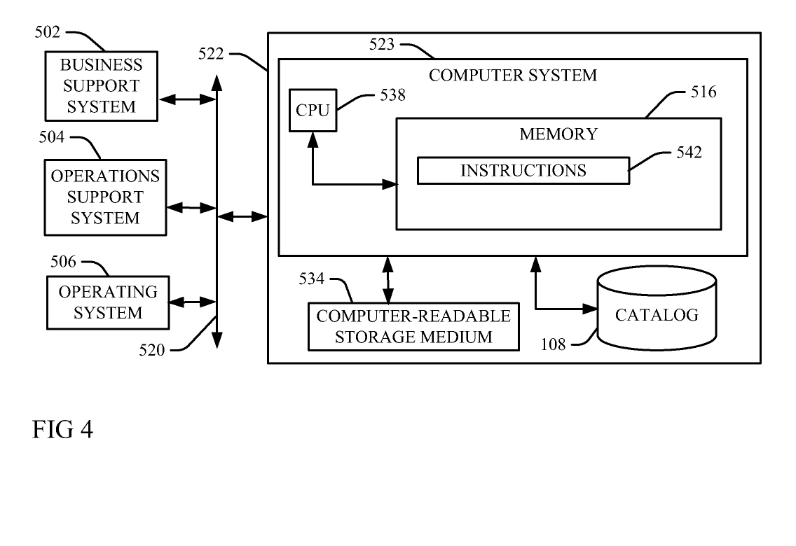

Referring now to FIG. 4, an exemplary computerized implementation of an aspect of the present invention includes a computer system or other programmable device 522 in communication 520 with a business support system 502, an operations support system 504, an operating system 506 and the catalog 108. The programmable device 522 thus provides for the automatic generation of behavioral attributes for product specifications and properties as a function of templates for similar products stored in a central catalog 108, for exporting conditional behavior properties in appropriate syntax and translation form to rules engines of each of the business support system 502, operations support system 504, and operating system 506, as discussed above with respect to FIGS. 1, 2 and 3. Instructions 542 reside within computer readable code in a computer readable memory 516, or in a computer readable storage system 532, or other tangible computer readable storage medium 534 that is accessed by a Central Processing Unit (processor or CPU) 538 of a computer system or infrastructure 523 of the programmable device 522. Thus, the instructions, when implemented by the processor 538, cause the processor 538 to automatic generate templates of behavioral attributes, and export conditional behavior properties of the templates in appropriate syntax and translation form to rules engines of each of the business support system 502, operations support system 504, and operating system 506, as discussed above with respect to FIGS. 1, 2 and 3.

In one aspect, the present invention may also perform process steps of the invention on a subscription, advertising, and/or fee basis. That is, a service provider could offer to integrate computer-readable program code into the computer system 522 to enable the computer system 522 to generate templates of behavioral attributes, and export conditional behavior properties of the templates in appropriate syntax and translation form to the rules engines of different consuming systems, as discussed above with respect to FIGS. 1-4. The service provider can create, maintain, and support, etc., a computer infrastructure, such as the computer system 522, network environment 520, or parts thereof, that perform the process steps of the invention for one or more customers. In return, the service provider can receive payment from the customer(s) under a subscription and/or fee agreement and/or the service provider can receive payment from the sale of advertising content to one or more third parties. Services may include one or more of: (1) installing program code on a computing device, such as the computer device 522, from a tangible computer-readable medium device 532 or 534; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The aspect was chosen and described in order to best explain the principles of the invention and the practical application, and to enable others of ordinary skill in the art to understand the invention for various embodiments with various modifications as are suited to the particular use contemplated.

The flowchart and block diagrams in the figures illustrate the architecture, functionality, and operation of possible implementations of systems, methods and computer program products according to various aspects of the present invention. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for maintaining product behavior data via a product catalog, the method comprising:
a processor creating a first product template from attributes of an offer for a first product by defining a first product template conditional behavior as a function of a set of selectable data values of the attributes of the first product;
the processor translating the first product template into a first product template export that has a first syntax that is executable by a rule engine of a first of a plurality of business support, operations support or operating systems to generate a first rule in the first syntax that is representative of the conditional behavior for the first product and executable by the first system; and
the processor translating the first product template into another first product template export that has a second syntax that is different from the first syntax and is executable by a rule engine of a second of the plurality of business support, operations support or operating systems to generate the first rule in the second syntax that is representative of the conditional behavior for the first product and is executable by the second system.

2. The method of claim 1, further comprising:
integrating computer-readable program code into a computer system comprising the processor, a computer readable memory and a computer readable storage medium, wherein the computer readable program code is embodied on the computer readable storage medium and comprises instructions that, when executed by the processor via the computer readable memory, cause the processor to perform the steps of creating the first product template from the attributes of the offer for the first product, translating the first product template into the first product template export; and translating the first product template into the another first product template export.

3. The method of claim 1, further comprising:
in response to an input of a new product that is different from the first product, determining whether the new product is similar to the first product;
in response to determining that the new product is similar to the first product, using the first template to select attributes of the new product and create a new product template by defining a new product template conditional behavior as a function of a set of selectable data values of the selected attributes of the new product; and
in response to determining that the new product is not similar to the first product, creating the new product template from attributes of the offer for the new product by defining the new product template conditional behavior as a function of a set of selectable data values of attributes of the new product.

4. The method of claim 3, wherein the step of determining whether the new product is similar to the first product comprises determining:
whether the first product and the new product belong to a common product grouping or category;
whether they have a common relative ranking of respective values of a common specification field; or
whether they have respective values of a common specification field that meet a threshold value.

5. The method of claim 3, wherein the step of determining whether the new product is similar to the first product comprises:
determining a location of the new product relative to a location of the first product within a hierarchy in a catalog comprising the first and the new products; and
determining that the new product is similar to the first product in response to determining that the location of the new product relative to the location of the first product within the hierarchy is within a threshold distance value.

6. The method of claim 3, wherein the inputs of attributes of the offers for the first product and the new product comprise variable values selected from pull-down box fields in a graphical user interface.

7. The method of claim 3, further comprising:
translating the new product template into a first new product template export that has the first syntax that is executable by the rule engine of the first system to generate the first rule in the first syntax that is representative of the conditional behavior for the new product and executable by the first system;
translating the new product template into another new product template export that has the second syntax and is executable by the rule engine of the second system to generate the first rule in the second syntax that is representative of the conditional behavior for the new product and is executable by the second system; and
storing the first product template, the first product template export, the another first product template export, the new product template, the new product template export and the another new product template export in a repository that is in communication with the first system and the second system.

8. The method of claim 7, further comprising, in response to an entry of an update of the specification of the first product that is associated with the set of selectable data values of the first product template, automatically:
generating an updated first product template that defines an updated conditional behavior for the first product as a function of a set of updated selectable data values that are associated with the updated specification of the first product;
translating the updated first product template into an updated first product template export that has the first syntax that is executable by the rule engine of the first system to generate an update of the first rule in the first syntax that is representative of the updated conditional behavior for the first product;
translating the updated first product template into another updated first product template export that has the second syntax that is executable by the rule engine of the second system to generate an update of the first rule in the second syntax that is representative of the updated conditional behavior for the first product; and
storing the updated first product template, the updated first product template export, and the another updated first product template export in the repository.

9. A system, comprising:
a processor; a computer readable memory in circuit communication with the processor; and
a computer readable storage medium in circuit communication with the processor;
wherein the processor, when executing program instructions stored on the computer-readable storage medium via the computer readable memory:
creates a first product template from attributes of an offer for a first product by defining a first product template conditional behavior as a function of a set of selectable data values of the attributes of the first product;
translates the first product template into a first product template export that has a first syntax that is executable by a rule engine of a first of a plurality of business support, operations support or operating systems to generate a first rule in the first syntax that is representative of the conditional behavior for the first product and executable by the first system; and
translates the first product template into another first product template export that has a second syntax that is different from the first syntax and is executable by a rule engine of a second of the plurality of business support, operations support or operating systems to generate the first rule in the second syntax that is representative of the conditional behavior for the first product and is executable by the second system.

10. The system of claim 9, wherein the processor, when executing the program instructions stored on the computer-readable storage medium via the computer readable memory, further:
determines whether a new product that is different from the first product is similar to the first product in response to an input of the new product that comprises attributes of the new product;
uses the first template to select attributes of the new product and create a new product template by defining a new product template conditional behavior as a function of a set of selectable data values of the selected attributes of the new product, in response to determining that the new product is similar to the first product; and
creates the new product template from attributes of the offer for the new product by defining the new product template conditional behavior as a function of a set of selectable data values of attributes of the new product, in response to determining that the new product is not similar to the first product.

11. The system of claim 10, wherein the processor, when executing the program instructions stored on the computer-readable storage medium via the computer readable memory, determines whether the new product is similar to the first product by determining:
whether the first product and the new product belong to a common product grouping or category;
whether they have a common relative ranking of respective values of a common specification field; or
whether they have respective values of a common specification field that meet a threshold value.

12. The system of claim 10, wherein the processor, when executing the program instructions stored on the computer-readable storage medium via the computer readable memory, determines whether the new product is similar to the first product by:
determining a location of the new product relative to a location of the first product within a hierarchy in a catalog comprising the first and the new products; and
determining that the new product is similar to the first product in response to determining that the location of the new product relative to the location of the first product within the hierarchy is within a threshold distance value.

13. The system of claim 10, wherein the processor, when executing the program instructions stored on the computer-readable storage medium via the computer readable memory, further:
translates the new product template into a first new product template export that has the first syntax that is executable by the rule engine of the first system to generate the first rule in the first syntax that is representative of the conditional behavior for the new product and executable by the first system;
translates the new product template into another new product template export that has the second syntax and is executable by the rule engine of the second system to generate the first rule in the second syntax that is representative of the conditional behavior for the new product and is executable by the second system; and
stores the first product template, the first product template export, the another first product template export, the new product template, the new product template export and the another new product template export in a repository that is in communication with the first system and the second system.

14. The system of claim 10, wherein the processor, when executing the program instructions stored on the computer-readable storage medium via the computer readable memory, in response to an entry of an update of the specification of the first product that is associated with the set of selectable data values of the first product template, further:
generates an updated first product template that defines an updated conditional behavior for the first product as a function of a set of updated selectable data values that are associated with the updated specification of the first product;
translates the updated first product template into an updated first product template export that has the first syntax that is executable by the rule engine of the first system to generate an update of the first rule in the first syntax that is representative of the updated conditional behavior for the first product;
translates the updated first product template into another updated first product template export that has the second syntax that is executable by the rule engine of the second system to generate an update of the first rule in the second syntax that is representative of the updated conditional behavior for the first product; and
stores the updated first product template, the updated first product template export, and the another updated first product template export in the repository.

15. A computer program product for maintaining dynamic product behavior data via a product catalog, the computer program product comprising:
a computer readable storage medium having computer readable program code embodied therewith, the computer readable program code comprising instructions that, when executed by a processor, cause the processor to:
create a first product template from attributes of an offer for a first product by defining a first product template conditional behavior as a function of a set of selectable data values of the attributes of the first product;
translate the first product template into a first product template export that has a first syntax that is executable by a rule engine of a first of a plurality of business support, operations support or operating systems to generate a first rule in the first syntax that is representative of the conditional behavior for the first product and executable by the first system; and
translate the first product template into another first product template export that has a second syntax that is different from the first syntax and is executable by a rule engine of a second of the plurality of business support, operations support or operating systems to generate the first rule in the second syntax that is representative of the conditional behavior for the first product and is executable by the second system.

16. The computer program product of claim 15, wherein the computer readable program code instructions, when executed by the processor, further cause the processor to:
determine whether a new product that is different from the first product is similar to the first product in response to an input of the new product that comprises attributes of the new product;
use the first template to select attributes of the new product and create a new product template by defining a new product template conditional behavior as a function of a set of selectable data values of the selected attributes of the new product, in response to determining that the new product is similar to the first product; and
create the new product template from attributes of the offer for the new product by defining the new product template conditional behavior as a function of a set of selectable data values of attributes of the new product, in response to determining that the new product is not similar to the first product.

17. The computer program product of claim 16, wherein the computer readable program code instructions, when executed by the processor, further cause the processor to determine whether the new product is similar to the first product by determining:
whether the first product and the new product belong to a common product grouping or category;
whether they have a common relative ranking of respective values of a common specification field; or
whether they have respective values of a common specification field that meet a threshold value.

18. The computer program product of claim 16, wherein the computer readable program code instructions, when executed by the processor, further cause the processor to determine whether the new product is similar to the first product by:
determining a location of the new product relative to a location of the first product within a hierarchy in a catalog comprising the first and the new products; and
determining that the new product is similar to the first product in response to determining that the location of the new product relative to the location of the first product within the hierarchy is within a threshold distance value.

19. The computer program product of claim 16, wherein the computer readable program code instructions, when executed by the processor, further cause the processor to:
translate the new product template into a first new product template export that has the first syntax that is executable by the rule engine of the first system to generate the first rule in the first syntax that is representative of the conditional behavior for the new product and executable by the first system;
translate the new product template into another new product template export that has the second syntax and is executable by the rule engine of the second system to generate the first rule in the second syntax that is representative of the conditional behavior for the new product and is executable by the second system; and
store the first product template, the first product template export, the another first product template export, the new product template, the new product template export and the another new product template export in a repository that is in communication with the first system and the second system.

20. The computer program product of claim 19, wherein the computer readable program code instructions, when executed by the processor, further cause the processor to:
generate an updated first product template that defines an updated conditional behavior for the first product as a function of a set of updated selectable data values that are associated with the updated specification of the first product;
translate the updated first product template into an updated first product template export that has the first syntax that is executable by the rule engine of the first system to generate an update of the first rule in the first syntax that is representative of the updated conditional behavior for the first product;
translate the updated first product template into another updated first product template export that has the second syntax that is executable by the rule engine of the second system to generate an update of the first rule in the second syntax that is representative of the updated conditional behavior for the first product; and
store the updated first product template, the updated first product template export, and the another updated first product template export in the repository.
